(19) United States
(12) Patent Application Publication
(10) Pub. No.: US 2024/0266860 A1
(43) Pub. Date: Aug. 8, 2024

(54) POWER SUPPLY SYSTEM

(71) Applicant: TOYOTA JIDOSHA KABUSHIKI KAISHA, Toyota-shi (JP)

(72) Inventors: Yasuhiro Endo, Toyota-shi (JP); Junta Izumi, Nagoya-shi (JP); Hironori Miki, Nagoya-shi (JP); Kenji Kimura, Nagoya-shi (JP); Takayuki Ban, Nishio-shi (JP); Takuya Mizuno, Nagakute-shi (JP); Shuji Tomura, Nagakute-shi (JP); Naoki Yanagizawa, Nagakute-shi (JP); Kazuo Ootsuka, Nagakute-shi (JP); Hiroshi Tsukada, Nagakute-shi (JP)

(73) Assignee: TOYOTA JIDOSHA KABUSHIKI KAISHA, Toyota-shi (JP)

(21) Appl. No.: 18/421,135

(22) Filed: Jan. 24, 2024

(30) Foreign Application Priority Data
Feb. 3, 2023 (JP) 2023-015432

(51) Int. Cl. H02J 7/00

(52) U.S. Cl. CPC H02J 7/007186; H02J 7/0024; H02J 7/0025; H02J 7/0016

(57) ABSTRACT

The battery string is configured so that a plurality of battery circuit modules can be connected in series. The drive circuit SU5 from the drive circuit SU0 of the battery circuit module transmits a gate signal for ON/OFF of the switch to the downstream drive circuit SU while delaying the gate signal by a predetermined delay time Td. When a particular battery circuit module (drive circuit SU4 in FIG. 4) is passed through, the delay time is switched from the delay time Td to the delay time Tds. The delay time Tds is longer than the delay time Td. As a result, the period of the gate signal, which is the “delay time×the number of battery circuit modules to be operated”, can be suppressed from becoming short (the increase in frequency can be suppressed), and an increase in loss can be suppressed.

### CROSS-REFERENCE TO RELATED APPLICATION

This application claims priority to Japanese Patent Application No. 2023-015432 filed on Feb. 3, 2023, incorporated herein by reference in its entirety.

### BACKGROUND

### 1. Technical Field

The present disclosure relates to a power supply system.

### 2. Description of Related Art

Japanese Unexamined Patent Application Publication No. 2022-120255 (JP 2022-120255A) discloses a power supply system that outputs alternating current (AC) power (AC voltage) using a battery string in which a plurality of battery circuit modules can be connected in series. The battery circuit module included in the battery string includes a battery, a first switch connected in parallel to the battery, a second switch connected in series to the battery, and a first output terminal and a second output terminal to which a voltage of the battery is applied when the first switch is in an OFF state and the second switch is in an ON state. The ON and OFF states of the first switch and the second switch are controlled by a gate signal, and the gate signal is transmitted to a battery circuit module of the subsequent stage connected in series at a predetermined delay time. By controlling the first switch and the second switch of each battery circuit module included in the battery string with the gate signal, the output voltage of the battery string can be adjusted to a desired magnitude.

JP 2022-120255 A describes that when a battery of a particular battery circuit module fails, for example, the battery of the particular battery circuit module is controlled to a forcibly disconnected state (pass-through state) by constantly setting the first switch to the ON state and the second switch to the OFF state.

### SUMMARY

The gate signal is controlled, for example, by pulse width modulation (PWM) control, and the output voltage of the battery string is controlled by controlling a duty ratio. The cycle of the PWM control (the cycle of the gate signal) is calculated by the sum of the delay times of the battery circuit modules in operation (not forcibly disconnected) (the delay time×the total number of the battery circuit modules in operation). When the battery circuit module is in the pass-through state, the total number of the battery circuit modules in operation decreases, and the cycle is shortened, so that the drive frequency of the gate signal increases. When the drive frequency increases, the loss (for example, switching loss) increases.

An object of the present disclosure is to suppress an increase in the loss even when the pass-through state occurs in the power supply system using the battery string.

(1) A power supply system according to the present disclosure includes a battery circuit module, a battery string in which a plurality of the battery circuit modules is connected in series, and a control device for controlling the battery string. The battery circuit module includes a battery, a first switch connected in parallel to the battery, a second switch connected in series to the battery, and a first output terminal and a second output terminal to which a voltage of the battery is applied when the first switch is in an OFF state and the second switch is in an ON state. The control device transmits a gate signal for switching the ON state and the OFF state of the first switch and the second switch to the battery circuit module on a downward side by delaying the gate signal in increments of a predetermined delay time, and sets a cycle of the gate signal to “a delay time×the number of the battery circuit modules in operation”. The control device sets the delay time to a first delay time Td when all of the battery circuit modules included in the battery string are operated without being disconnected, and sets the delay time to a second delay time Tds longer than the first delay time when a battery of a particular battery circuit module is in a forcibly disconnected state.

According to this configuration, the gate signal for turning ON and OFF the first switch and the second switch of the battery circuit module is delayed in increments of a predetermined delay time, and transmitted to the battery circuit module on the downstream side. Then, by setting the cycle of the gate signal to “the delay time×the number of the battery circuit modules in operation”, the duty ratio of the gate signal is controlled, and the output voltage of the battery string is controlled.

When the battery of the particular battery circuit module included in the battery string is forcibly disconnected, the number of the battery circuit modules in operation decreases, the cycle of the gate signal is shortened, and the frequency of the gate signal increases.

The control device sets the delay time to the second delay time Tds when the battery of the particular battery circuit module is in a forcibly disconnected state (pass-through state). The second delay time Tds is set to be longer than the first delay time Td set when all of the battery circuit modules included in the battery string are operated without being disconnected. Therefore, even when the number of the battery circuit modules in operation decrease when the battery of the particular battery circuit module is forcibly disconnected, it is possible to suppress a decrease in the cycle of the gate signal and an increase in the frequency of the gate signal. Thus, even when the pass-through state occurs, an increase in the loss can be suppressed.

The second delay time Tds is set in accordance with the number of the forcibly disconnected battery circuit modules, and the second delay time Tds may be set longer as the number of the forcibly disconnected battery circuit modules is high. This makes it possible to suppress a large change in the frequency of the gate signal.

(2) Preferably, when the total number of the battery circuit modules included in the battery string is No and the number of the forcibly disconnected battery circuit modules is Ns, the control device may set the second delay time Tds according to a following equation, “Tds=Td×(No/(No−Ns))”.

According to this configuration, since the cycle of the gate signal at the first delay time Td and the cycle of the gate signal at the second delay time Tds can be made substantially the same, the frequency of the gate signal can be kept constant even when the pass-through state occurs, so that an increase in the loss can be suppressed.

(3) The control device controls an output voltage of the battery string by controlling a duty ratio of the gate signal. The control device may set, when the output voltage is controlled to a predetermined value, and an ON time of the gate signal at the first delay time Td is Ton, an ON time T′on of the gate signal at the second delay time Tds according to a following equation, T′on=Ton×(No/(No−Ns)).

According to this configuration, even when the delay time is switched from the first delay time Td to the second delay time Tds, it is possible to perform control such that the output voltage of the battery string does not change.

(4) A power supply system according to the present disclosure includes a battery circuit module, a battery string in which a plurality of the battery circuit modules is connected in series, and a control device for controlling the battery string. The battery circuit module includes a battery, a first switch connected in parallel to the battery, a second switch connected in series to the battery, and a first output terminal and a second output terminal to which a voltage of the battery is applied when the first switch is in an OFF state and the second switch is in an ON state. The control device transmits a gate signal for switching the ON state and the OFF state of the first switch and the second switch to the battery circuit module on a downward side by delaying the gate signal in increments of a predetermined delay time, and sets a cycle of the gate signal to “a delay time×the number of the battery circuit modules in operation”. When the number of the battery circuit modules in operation included in the battery string is Np, the control device sets the delay time to a first delay time Tda, and when a battery of a particular battery circuit module is forcibly disconnected, and the number of the battery circuit modules in operation is Nr smaller than Np, the control device sets the delay time to a second delay time Tdt, and sets the second delay time Tdt according to a following equation, “Tdt=Tda×(Np/Nr)”.

According to this configuration, the delay time is set to the first delay time Tda when the number of the battery circuit modules in operation included in the battery string is Np. Then, the delay time is set to the second delay time Tdt according to a following equation, Tdt=Tda×(Np/Nr) when the pass-through state occurs, and the number of the battery circuit modules in operation becomes Nr smaller than Np. Since the cycle of the gate signal at the first delay time Tda and the cycle of the gate signal at the second delay time Tdt can be made substantially the same, it is possible to suppress an increase in the frequency of the gate signal even when the number of the battery circuit modules in operation decreases, so that an increase in the loss can be suppressed.

(5) In the above (1) to (4), when the particular battery circuit module is forcibly disconnected, and the battery circuit module on an uppermost upstream side included in the battery string is driven, the control device may change the delay time from the first delay time (Td or Tda) to the second delay time (Tds or Tdt).

According to this configuration, when the pass-through state occurs, and the battery circuit module on the uppermost upstream side is driven, the delay time is changed from the first delay time (Td or Tda) to the second delay time (Tds or Tdt). As a result, it is possible to suppress occurrence of disturbance in the output voltage of the battery string.

According to the present disclosure, in the power supply system using the battery string, it is possible to suppress an increase in the loss even when the pass-through state occurs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a power supply system according to an embodiment of the present disclosure;

FIG. 2A is a diagram illustrating operation of a battery circuit module controlled by a gate-signal;

FIG. 2B is a diagram illustrating operation of a battery circuit module controlled by a gate-signal;

FIG. 2C is a diagram illustrating operation of a battery circuit module controlled by a gate-signal;

FIG. 2D is a diagram illustrating operation of a battery circuit module controlled by a gate-signal;

FIG. 3 is a diagram illustrating a time chart of a gate signal in the present embodiment;

FIG. 4 is a diagram showing a time chart of a gate signal when returning from a pass-through state; and

FIG. 5 is a flowchart illustrating an example of a pass-through control process executed by the control device.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

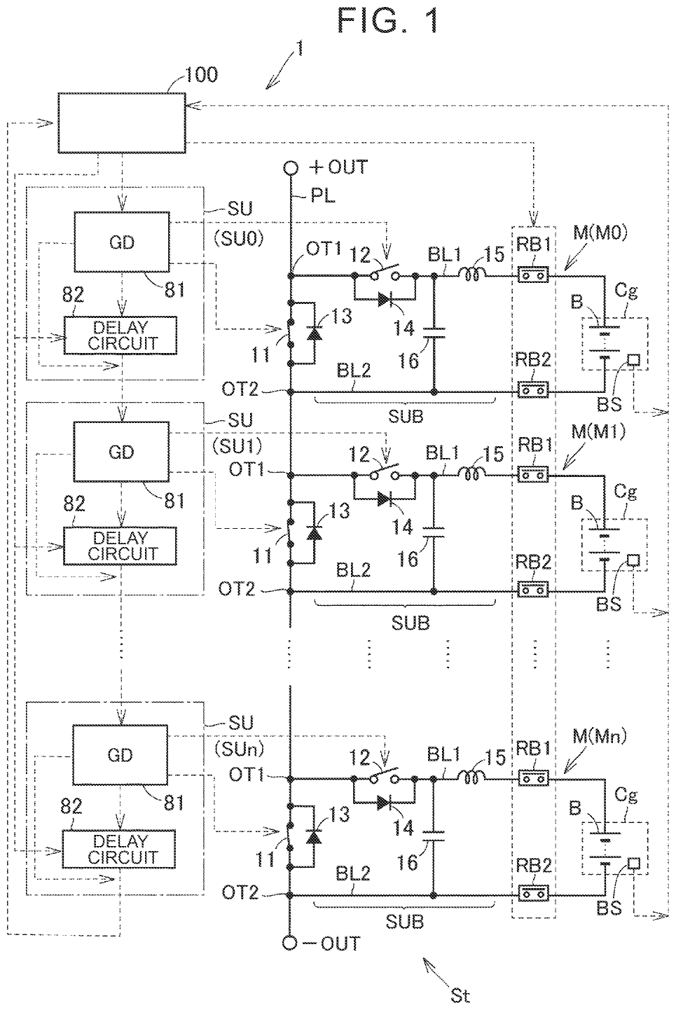

FIG. 1 is a diagram illustrating a configuration of a power supply system according to an embodiment of the present disclosure. Referring to FIG. 1, the power supply system 1 includes a battery string St and a control device 100. The control device 100 may be a computer, and includes, for example, a processor, a storage device, and a communication I/F (interface). The storage device stores, for example, a program executed by the processor and information (for example, a map, a mathematical expression, and various parameters) used in the program.

The battery string St includes a plurality of battery circuit modules M (M0-Mn: n is a positive integer including 0). The number of the battery circuit modules M included in the battery string St may be any number, and may be 5 to 50 or 100 or more.

Each of the battery circuit modules M includes a power circuit SUB and a cartridge Cg. The cartridge Cg includes a battery B and a monitoring unit BS. The power circuit SUB and the battery B are connected to each other to form a battery circuit module M including the battery B. The drive circuit SU is configured to drive switching elements (a SW11 and a SW12 described later) included in the battery circuit module M. The battery B may be a nickel-hydrogen secondary battery or a lithium-ion secondary battery, and the battery B may be manufactured by connecting the secondary batteries used in electrified vehicle in series.

As shown in FIG. 1, the battery circuit module M includes a power circuit SUB, a cartridge Cg, and a circuit breaker RB1 and a RB2 (hereinafter, referred to as “circuit breaker RB” unless otherwise distinguished). The power circuit SUB and the cartridge Cg are connected to each other via a circuit breaker RB1 and a RB2. The breaker RB switches between the power-circuit SUB and the cartridge Cg (conduction/disconnection) according to a command from the control device 100. The breaker RB may be configured for manual ON/OFF by a user, with the configuration allowing the cartridge Cg to be detachably attached to the power circuit SUB.

In the cartridge Cg, the monitoring unit BS is configured to detect the status of the battery B (e.g., voltage, current, and temperature) and to provide the detected data to the control device 100.

The battery circuit modules M included in the battery string St are connected by a common electric wire PL. The electric wire PL includes the output terminals OT1 and OT2 of the respective battery circuit modules M. The output terminal OT2 of the battery circuit module M is connected to the output terminal OT1 of the battery circuit module M adjoining the battery circuit module M, whereby the battery circuit modules M included in the battery string St are connected to each other.

The power circuit SUB includes a first switching element 11 (hereinafter referred to as “SW11”), a second switching element 12 (hereinafter referred to as “SW12”), a first diode 13, a second diode 14, a choke coil 15, a capacitor 16, and output terminals OT1 and OT2. Each of SW11 and SW12 is driven by the drive circuit SU. SW11, SW12 according to the present embodiment corresponds to exemplary “first switch” and “second switch”, respectively.

A SW11, a capacitor 16, and a battery B are connected in parallel between an output terminal OT1 and a OT2 of the power circuit SUB. SW11 is located on the electric wire PL and is configured to switch between an output terminal OT1 and an output terminal OT2. The output terminal OT1 is connected to the positive electrode of the battery B via the electric wire BL1, and the output terminal OT2 is connected to the negative electrode of the battery B via the electric wire BL2. The electric wire BL1 is further provided with a SW12 and a choke coil 15. In the battery circuit module M, when SW12 connected in series with the battery B is in ON state (connected state) and SW11 connected in parallel with the battery B is in OFF state (cut-off state), the voltage of the battery B is applied between the output terminal OT1 and OT2.

A capacitor 16 connected to each of the electric wire BL1 and the electric wire BL2 is provided between the output terminal OT1,OT2 and the battery B. Each of SW11 and SW12 is, for example, an FET (field-effect transistor). The first diode 13 and the second diode 14 are connected in parallel to SW11, SW12. Note that each of SW11 and SW12 is not limited to a FET, and may be a switching device other than a FET.

The control device 100 generates a gate signal. Drive circuit SU (SU0-SUn: n is a positive integer including 0) is provided for each battery circuit module M (M0-Mn), and includes a GD (gate driver) 81 that drives SW11 and SW12 according to a gate signal, and a delay circuit 82 that delays the gate signal. Each of SW11 and SW12 included in the battery circuit module M is ON/OFF controlled in accordance with the gate signal.

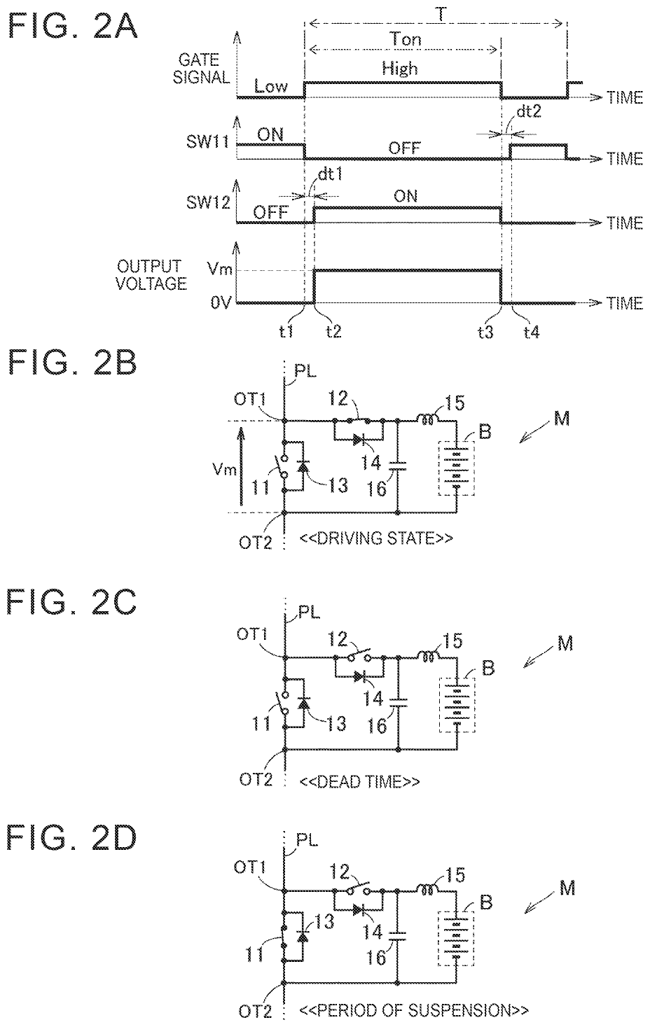

FIGS. 2A to 2D is a diagram for explaining the operation of the battery circuit module M controlled by the gate signal. FIG. 2A is a diagram illustrating an exemplary operation of a battery circuit module M, and in the present embodiment, a square-wave signal is adopted as a gating signal for driving a SW11 and a SW12. The “Low” and “High” of the gate signal shown in FIG. 2A refer to the L level and the H level of the gate signal (rectangular wave signal), respectively. The “output voltage” means a voltage output between the output terminals OT1 and OT2. In the initial state of the battery circuit module M, the gate signal is not inputted to the drive circuit SU (gate signal=L level), and SW11, SW12 are in ON state and OFF state, respectively. SW11 and SW12 are switched in ON/OFF according to the rising/falling edge of the gate-signal. The control device 100 performs PWM control using a gate-signal.

When a gate signal is input to the drive circuit SU, GD81 drives SW11 and SW12 in accordance with the input gate signal. In the embodiment shown in FIGS. 2A to 2D, the gate signal rises from the L level to the H level at the timing t1, and SW11 is switched from ON state to OFF state at the same time as the rising of the gate signal. Then, SW12 is switched from OFF state to ON state at a timing t2 delayed by a predetermined time (dead time dt1) from the rising edge of the gate-signal. As a result, the battery circuit module M is in the driving state (connected state), and as shown in FIG. 2B, SW11 is in OFF state and SW12 is in ON state, so that the voltage of the battery B is applied between the output terminal OT1 and OT2.

Referring to FIG. 2A, when the gate signal falls from the H level to the L level at the timing t3, SW12 is switched from ON state to OFF state at the same time as the falling of the gate signal. As a result, the battery circuit module M is stopped. In the battery circuit module M in the stopped state, SW12 is turned OFF, so that the voltage of the battery B is not applied between the output terminal OT1 and OT2. Thereafter, SW11 is switched from OFF state to ON state at a timing t4 delayed by a predetermined time (dead time dt2) from the falling edge of the gate-signal. The dead time dt1 and the dead time dt2 may be the same as or different from each other.

In the dead time dt1, dt2, both SW11 and SW12 are turned OFF as shown in FIG. 2C. As a result, SW11 and SW12 are suppressed from being turned ON at the same time (the battery circuit module M is short-circuited).

When the period from the end (t4) of the dead time dt2 until the battery circuit module M becomes the driving state is referred to as the “stopping period”, in the stopping period, SW11 is in ON state and SW12 is in OFF state as in the initial state, as shown in FIG. 2D.

The gate signal is delayed by a predetermined delay time Td by the delay circuit 82, and is transmitted from the upstream drive circuit SU to the downstream drive circuit SU. When receiving the gate signal from the delay circuit 82 of the most downstream drive circuit SU (SUn), the control device 100 outputs a new gate signal to the most upstream drive circuit SU (SU0). The period T of the gate signal is the sum of the delay times Td of the delay circuits 82 included in the battery string St, and when the number of all the battery circuit modules M included in the battery string St (the total number of the battery circuit modules M) is No, the period T is set as “T=Td×No”. Then, by controlling the duty ratio (H-level time: on-time Ton) of the gate signal, the number of the battery circuit modules M in the driving state (the number of the battery circuit modules M in the driving state at the same time) can be adjusted. When the delay time Td is set to be long, the frequency (1/T) of the gate-signal becomes a low frequency. When the delay time Td is set to be short, the frequency of the gate-signal becomes a high frequency. The delay time Td is set within an allowable loss (switching loss) according to, for example, the required specifications of the battery string St and the power supply system 1.

By controlling the battery circuit module M included in the battery string St as described above, the number of the battery circuit modules M in the driving state (the number of the battery circuit modules M in the driving state at the same time) can be adjusted, and the output-voltage of the battery string St can be controlled. Accordingly, the battery string St is capable of outputting a voltage from 0 [V] to the sum of the voltages of the batteries B (cartridge Cg) included in the battery string St.

When the battery B included in the battery string St is rapidly deteriorated or failed, or when SOC (State Of Charge) of the batteries B is equalized, there is a demand to exclude the battery B as a state (a pass-through state) in which the battery circuit module M of a particular type (an abnormal battery or a battery having a smaller SOC) is forcibly disconnected. Here, for example, GD81 of a particular battery circuit module M constantly turns ON SW11 and constantly turns OFF SW12, and transmits the gating signal to the downstream drive circuit SU by bypassing the delay circuit 82, thereby controlling the battery B of the particular battery circuit module M to the pass-through state.

When the battery circuit module M is in the pass-through state, the total number of the battery circuit modules M that operate (not in the pass-through state) is reduced, and the period T of the gate signal is shortened, so that the frequency (1/T) of the gate signal is increased. As the frequency increases, the loss (e.g., switching loss) increases. In the present embodiment, when a pass-through condition occurs, the delay time Td is increased to suppress the frequency of the gate-signal from being increased.

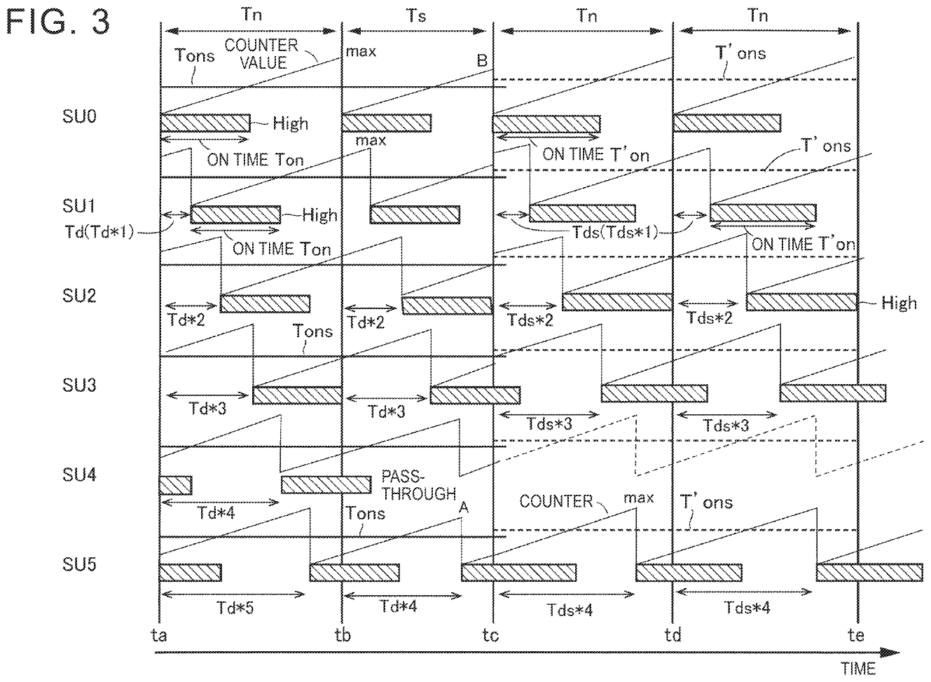

FIG. 3 is a diagram illustrating a time chart of a gate signal in the present embodiment. In the battery string St shown in FIG. 3, the total number No of the battery circuit modules M is six, and a drive circuit SU (SU0-SU5) corresponding to six battery circuit modules M (M0-M5) is provided. Referring to FIG. 3, the hatched portion is an H-level of the gate-signal and corresponds to the on-time Ton. In FIG. 3, the duty ratio when the pass-through state is not generated is set to 50%.

Referring to FIG. 3, according to the gate signal of the control device 100, at the time ta, the most upstream drive circuit SU0 outputs the H level of the gate signal (the gate signal rises from the L level to the H level). The drive circuit SUn outputs the H level after “delay time Td×n” elapses from the time ta (when the drive circuit SU0 outputs the H level). For example, the drive circuit SU2 outputs an H level after “delay time Td×2” has elapsed from the time ta, and outputs an H level after “delay time Td×5” has elapsed from the time ta in the most-downstream drive circuit SU5. Then, the control device 100 outputs a new gating signal from the drive circuit SU5 to the time tb after the lapse of the delay time Td from the time of output of the H level signal (after the lapse of the “delay time Td×6” from the time ta), and the subsequent control cycle starts. In the present control cycle, the cycle Tn of the gate-signal becomes “delay time Td×6 (total number No of the battery circuit modules M)”.

After the subsequent control cycle is started, for example, when a pass-through state occurs in the drive circuit SU4 (circuit module M4), the gate-signal is not outputted from the drive circuit SU4, SW11 is constantly turned ON, and SW12 is constantly turned OFF. The drive circuit SU5 downstream of the drive circuit SU4 outputs an H-level signal after “delay time Td×4” has elapsed from the time Tb. The periodic Ts of the gate signal becomes “delay time Td×5”, and the frequency of the gate signal becomes higher than that of the previous time.

When the pass-through condition occurs, the delay time Td is switched to the delay time Tds in the next control cycle (at the time tc at which the most upstream drive circuit SU0 outputs the gating signal). The delay time Tds is set as “Tds=Td×(No/(No−Ns))” when the number of all the battery circuit modules M included in the battery string St (the total number of the battery circuit modules included in the battery string St) is No and the number of the battery circuit modules M in the pass-through condition is Ns. In the case of FIG. 3, since No is 6 and Ns is 1, it is set to “Tds=Td×( 6/5)”. When the drive circuit SU4 (the battery circuit module M4) is passed through, as shown in FIG. 3, the delay time is switched from the delay time Td to the delay time Tds after the time tc. Further, since the gate signal is transmitted by bypassing the delay circuit 82 of the drive circuit SU4 which is in the pass-through state, the drive circuit SU5 outputs an H-level signal after “delay time Tds×4” has elapsed from the time Tc. As described above, since the delay time is switched from the delay time Td to the delay time Tds when the pass-through state occurs, the cycle of the gate signal after the time tc is the cycle Tn, and the frequency of the gate signal can be made same as the frequency when the pass-through state is not generated, and the frequency can be suppressed from increasing. Note that delay time Td corresponds to an example of the “first delay time Td” of the present disclosure, and the delay time Tds corresponds to an example of the “second delay time Tds” of the present disclosure.

In FIG. 3, the duty cycle when the pass-through condition is not occurring is 50%, and the on-time Ton (the time of the H-level) of the gate-signal is ½ of the cycle Tn. When a pass-through condition occurs and the delay time is switched from the delay time Td to the delay time Tds, the output-voltage of the battery string St fluctuates (changes) when the duty cycle remains at 50%. Therefore, the on-time T′on of the gate-signal in the delay time Tds is calculated as “T′on=Ton×(No/(No−Ns))”. When the delay time is the delay time Tds, the on-time of the gate-signal (the time of the H-level) is controlled to be the on-time T′on (the duty cycle is controlled to be the on-time T′on). Thus, the output-voltage of the battery string St can be suppressed from fluctuating.

When the H level (on time)/L level of the gate signal outputted from GD81 is generated by using a counter (carrier counter) provided in the drive circuit SU, the counter value is reset to be “0” when the maximum value max corresponding to the cycle Tn is reached, as shown in FIG. 3. The timing at which the counter value of the drive circuit SU is reset to the maximum value max (the timing at which the counter starts counting) is the timing at which the above-described drive circuits SU output the H level of the gate signal. When a pass-through condition occurs, in the control cycle, the maximum value max of the drive circuit SU after the pass-through and the maximum value max of the drive circuit SU0 most upstream are set to be small by a value corresponding to the delay time Td (the value obtained by subtracting Td from the maximum value max is set to the maximum value max (see A and B in FIG. 3). When a pass-through condition occurs, the counter value of the drive circuit SUn other than the most upstream drive circuit SU0 is set to the value “max value max-delay time Tds×n” at the beginning of the next control cycle (see the counter value of the drive circuit SU1-SU5 at time tc in FIG. 3).

The drive circuit SU (GD81) outputs an H level when the counter value is equal to or less than the threshold value, and outputs an L level when the counter value exceeds the threshold value. When the delay time is the delay time Td, the threshold is set to the threshold Tons corresponding to the on time Ton, and when the delay time is switched to the delay time Tds, the threshold is set to the threshold T′ons corresponding to the on time T′on. The thresholds T′ons can be calculated as “T′ons=Tons×(No/(No−Ns))”, similarly to the on-time T′on.

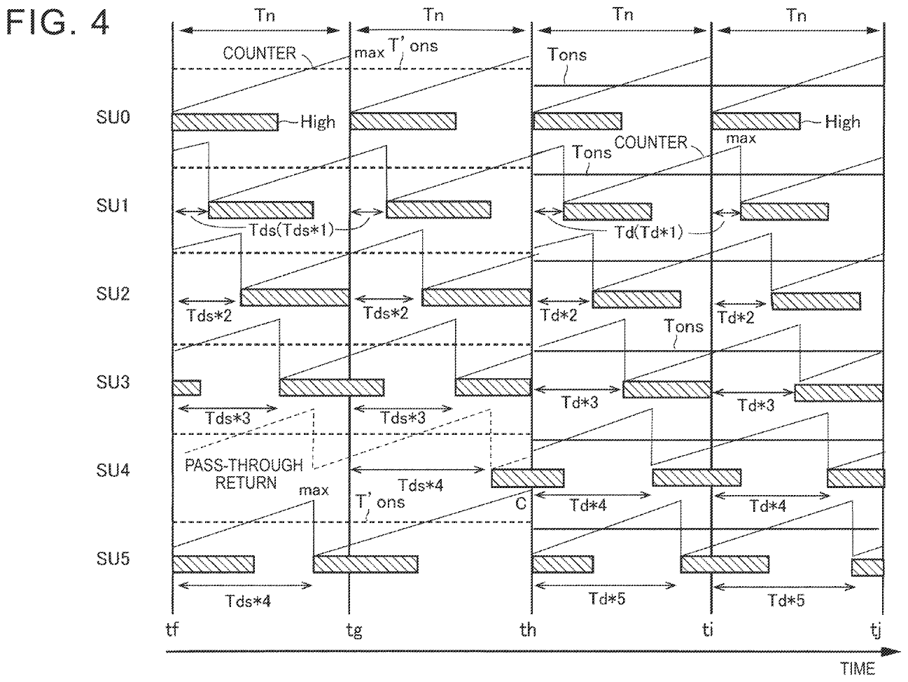

FIG. 4 is a diagram illustrating a time chart of a gate signal when returning from a pass-through state. The hatched portion is the H level of the gate signal. When the drive circuit SU4 (the battery circuit module M4) returns from the pass-through state, as shown in FIG. 4, the drive circuit SU4 outputs the H level of the gate signal after “delay time Tds×4” has elapsed from the time when the drive circuit SU0 outputs the H level (time tg). The drive circuit SU5 is controlled to output the H level after “delay time Tds×5” has elapsed from the time tg, but in the example shown in FIG. 4, since the next control cycle is entered by the cycle Tn, the H level is not output in the present control cycle. In the control cycle after the drive circuit SU4 returns from the pass-through state, the delay time is switched from the delay time Tds to the delay time Td, the on-time is set to the on-time Ton, and the gate signal is outputted from the drive circuit SU.

In the counter provided in the drive circuit SU, the maximum value max of the drive circuit SU (in the example of FIG. 4, the drive circuit SU5) after the pass-through state is restored is set to a value obtained by adding the delay time Tds to the maximum value max (see C of FIG. 4). Further, when returning from the pass-through state, at the beginning of the next control cycle, the counter value of the drive circuit SUn other than the most upstream drive circuit SU0 is set to the value of “max value max-delay time Td×n” (see the counter value of the drive circuit SU1-SU5 at time th in FIG. 4).

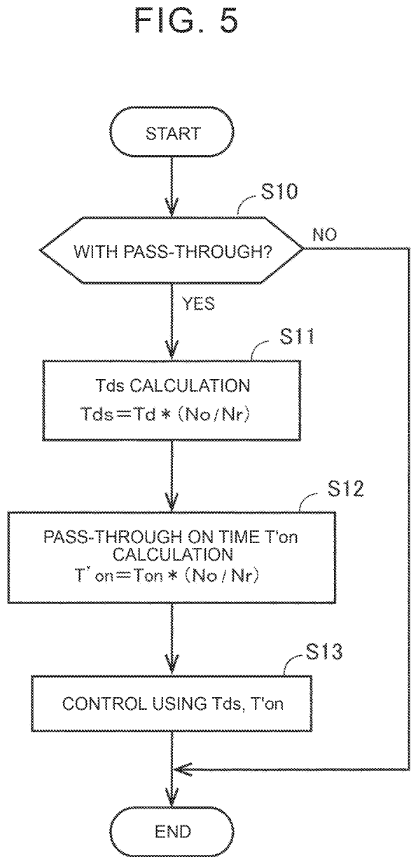

FIG. 5 is a flowchart illustrating an example of a pass-through control process executed by the control device 100. This flowchart is repeatedly processed every predetermined period during the operation of the power supply system 1. In step (hereinafter, step is abbreviated as “S”) 10, it is determined whether or not there is a battery circuit module M (drive circuit SU) in a pass-through condition. When there is no battery circuit module M in the pass-through state, a negative determination is made, and the present routine is ended. If there is a pass-through battery circuit module M, an affirmative determination is made and the process proceeds to S11.

In S11, the delay time Tds in the bus-through condition is calculated. If the delay time when no pass-through condition occurs is taken as a delay time Td, the delay time Tds is calculated as “Tds=Td×(No/Nr)”. No is the total number of battery circuit modules M included in the battery string St, and Nr is the number of battery circuit modules that are in operation (not in a pass-through condition). It should be noted that this is Nr=No−Ns (the number of battery circuit modules in the pass-through state).

In the following S12, the on-time T′on of the gate-signal in the pass-through condition is calculated. Assuming that the ON time when the pass-through condition does not occur is the ON time Ton, the ON time T′on is calculated as “T′on=Ton×(No/Nr)”. In S13, the battery string St (drive circuit SU) is controlled by using the delay time Tds and the on-time T′on.

According to the present embodiment, the control device 100 sets the delay time Td to the delay time Tds when the battery B of the particular battery circuit module M is forcibly disconnected (pass-through state). The delay time Tds is set to be longer than the delay time Td when no pass-through condition occurs. Therefore, even if the number of battery circuit modules operated by the pass-through decreases, the period of the gate signal can be suppressed from becoming short, the frequency of the gate signal can be suppressed from becoming high, and an increase in loss can be suppressed. In addition, since the second delay time Tds is set to be longer as the number of the battery circuit modules M in the pass-through state increases, it is possible to prevent a large change in the frequency of the gate signal.

### MODIFICATION

In the above embodiment, the delay time when all the battery circuit modules M included in the battery string St are operated is set to the delay time Td, and the delay time when the pass-through state occurs is set to the delay time Tds(=Td×No/Nr) (No: total number of battery circuit modules M included in the battery string St, Nr: number of battery circuit modules that are operated (not in the pass-through state)). However, when the number of the battery circuit modules M included in the battery string St is large and the number of the battery circuit modules M to be passed through is small, the number of the battery circuit modules M to be operated is large even when the number of the battery circuit modules M is controlled using the delay time Td, and the frequency of the gate signal may not exceed an allowable range.

In a variant, a delay time Tda is used to control the battery string St (drive circuit SU) until a pass-through condition occurs and the number of battery circuit modules M operating is at a Np less than No (total number). The delay time Tda may be the same as the delay time Td of the above embodiment. Np is the smallest integer that satisfies “Np>1/(Tda×Hc)” when the loss (e.g., switching loss) is Hc [Hz] as the allowable frequency. Then, when a pass-through condition occurs and the number of the battery circuit modules M to be operated becomes a Nr smaller than Np, the delay time is switched from the delay time Tda to the delay time Tdt. The delay time Tdt is calculated as “Tdt=Tda×(Np/Nr)”. The delay time Tda corresponds to an example of the “first delay time Tda” of the present disclosure, and the delay time Tdt corresponds to an example of the “second delay time Tdt” of the present disclosure. Note that the on-time of the gate signal is calculated in the same manner as in the above-described embodiment, and switching is performed.

The embodiments disclosed herein should be considered to be exemplary and not restrictive in all respects. The scope of the present disclosure is shown by the scope of claims rather than the description of the embodiments above, and is intended to include all modifications within the meaning and the scope equivalent to the scope of claims.

What is claimed is:

1. A power supply system comprising:
a battery circuit module including a battery, a first switch connected in parallel to the battery, a second switch connected in series to the battery, and a first output terminal and a second output terminal to which a voltage of the battery is applied when the first switch is in an OFF state and the second switch is in an ON state;
a battery string in which a plurality of the battery circuit modules is connected in series; and
a control device for controlling the battery string, wherein:
the control device transmits a gate signal for switching the ON state and the OFF state of the first switch and the second switch to the battery circuit module on a downward side by delaying the gate signal in increments of a predetermined delay time, and sets a cycle of the gate signal to “a delay time×the number of the battery circuit modules in operation”; and
the control device
sets the delay time to a first delay time Td when all of the battery circuit modules included in the battery string are operated without being disconnected, and
sets the delay time to a second delay time Tds longer than the first delay time when a battery of a particular battery circuit module is in a forcibly disconnected state.

2. The power supply system according to claim 1, wherein when the total number of the battery circuit modules included in the battery string is No and the number of the forcibly disconnected battery circuit modules is Ns, the control device sets the second delay time Tds according to a following equation, Tds=Td×(No/(No−Ns)).

3. The power supply system according to claim 2, wherein the control device
controls an output voltage of the battery string by controlling a duty ratio of the gate signal, and
sets, when the output voltage is controlled to a predetermined value, and an ON time of the gate signal at the first delay time is Ton, an ON time T′on of the gate signal at the second delay time according to a following equation, T′on=Ton×(No/(No−Ns)).

4. A power supply system comprising:
a battery circuit module including a battery, a first switch connected in parallel to the battery, a second switch connected in series to the battery, and a first output terminal and a second output terminal to which a voltage of the battery is applied when the first switch is in an OFF state and the second switch is in an ON state;
a battery string in which a plurality of the battery circuit modules is connected in series; and
a control device for controlling the battery string, wherein:
the control device transmits a gate signal for switching the ON state and the OFF state of the first switch and the second switch to the battery circuit module on a downward side by delaying the gate signal in increments of a predetermined delay time, and sets a cycle of the gate signal to “a delay time×the number of the battery circuit modules in operation”; and
when the number of the battery circuit modules in operation included in the battery string is Np, the control device sets the delay time to a first delay time Tda, and when a battery of a particular battery circuit module is forcibly disconnected, and the number of the battery circuit modules in operation is Nr smaller than Np, the control device sets the delay time to a second delay time Tdt, and sets the second delay time Tdt according to a following equation, Tdt=Tda×(Np/Nr).

5. The power supply system according to claim 1, wherein when the particular battery circuit module is forcibly disconnected, and the battery circuit module on an uppermost upstream side included in the battery string is driven, the control device changes the delay time from the first delay time to the second delay time.
